(19) United States
(12) Patent Application Publication
(10) Pub. No.: US 2011/0071887 A1
(43) Pub. Date: Mar. 24, 2011

(54) Multi-level real estate method and system

(76) Inventor: LAWRANCE RICHARD SMITH, CAPE CORAL, FL (US)

(21) Appl. No.: 12/586,197

(22) Filed: Sep. 18, 2009

(51) Int. Cl. G06Q 10/00; G06Q 50/00

(52) U.S. Cl. 705/11

(57) ABSTRACT

A method of compensating a plurality of participants, includes hierarchically representing, in a database communicatively associated with a computer, a multi-level real estate team, the team being based upon sponsoring of members in the team; collecting, from a real estate entity, a fee based at least in part on a real estate transaction; placing the collected fees into a revenue pool; determining by the computer, via interrogation against the database, a respective productivity bonus for respective team members based at least in part on the hierarchy between the team members; and distributing, based at least in part on the computer determination, the respective productivity bonuses from the revenue pool to respective team members.

### RELATED AND PRIORITY DOCUMENTS

This disclosure is related to, incorporates by reference in their entirety, and claims the priority benefit of the following:

U.S. patent application Ser. No. 12/460,709 entitled “MULTI-LEVEL REAL ESTATE METHOD AND SYSTEM” filed by SMITH on Jul. 23, 2009; and

U.S. patent application Ser. No. 12/380,673 entitled “MULTI-LEVEL REAL ESTATE METHOD AND SYSTEM” filed by SMITH on Mar. 2, 2009, which is related to, incorporated by reference in its entirety, and claimed the priority benefit of expired U.S. Provisional Patent Application Ser. No. 61/067,412 entitled “MULTI-LEVEL REAL ESTATE SYSTEM AND METHOD” filed by SMITH on Feb. 28, 2008.

### FIELD OF THE INVENTION

The present invention relates to real estate methods and system, and more specifically, to multi-level real estate methods and systems.

### BACKGROUND OF THE INVENTION

Real estate methods and systems are geared towards facilitating actions involved in real estate enterprises, which can include sales, leases, etc. of real estate. Multi-level systems and methods are geared towards incentivizing those involved in business enterprises.

### BRIEF SUMMARY OF THE INVENTION

It is, therefore, an object of the present invention to provide a multi-level real estate method and system.

In an exemplary embodiment of the present invention, a method of compensating a plurality of participants, can include the following steps: hierarchically representing, in a database communicatively associated with a computer, a multi-level real estate team, the team being based upon sponsoring of members in the team; collecting, from a real estate entity, a fee based at least in part on a real estate transaction; placing the collected fee into a revenue pool; determining by the computer, via interrogation against the database, a respective productivity bonus for respective team members based at least in part on the hierarchy of the team members; and distributing, based at least in part on the computer determination, the respective productivity bonuses from the revenue pool to respective team members.

According to an exemplary aspect of the present invention, the collected fee can include at least one fixed component, which can include a transaction fee, for example and not in limitation; and/or can include at least one variable component, which can include a royalty fee, for example and not in limitation.

According to another exemplary aspect of the present invention, the step of determining can include determining the respective productivity bonus for respective team members based upon: (i) a first level portion of the revenue pool, and (ii) a second level portion of the revenue pool.

According to an additional exemplary aspect of the present invention, at least one member can be at least one of a seller agent, a listing agent, a buyer agent, a real estate broker, a title agent, a lending agent, and a non-licensed participant.

According to still another exemplary aspect of the present invention, the team can include at least one member having sponsored at least one subsequent level of members into the team.

According to yet another exemplary aspect of the present invention, a bonused member receives a team bonus if the bonused member sponsored another member that was productive, or real estate-based productive.

According to a further exemplary aspect of the present invention, a real estate entity can be a real estate agent, and the collected fee can be a flat fee.

In another exemplary embodiment of the present invention, a computer system for effectuating a productivity bonus distribution for a multi-level real estate team can include the following: a database, communicatively associated with a computer, for hierarchically representing the multi-level real estate team, the team being based upon sponsoring of members in the team; and a determination module for determining via computer interrogation against the database a respective productivity bonus for respective team members based at least in part on the hierarchy of the team members; wherein the respective productivity bonuses are funded from a revenue pool funded from a fee, collected from a real estate entity, and being based at least in part on a real estate transaction.

According to an exemplary aspect of the present invention, also here, the collected fee can include at least one fixed component, which can include a transaction fee, for example and not in limitation; and/or can include at least one variable component, which can include a royalty fee, for example and not in limitation.

According to another exemplary aspect of the present invention, the determination module can determine the respective productivity bonus for respective team members based upon: (i) a first level portion of the revenue pool, and (ii) a second level portion of the revenue pool.

According to another exemplary aspect of the present invention, at least one team member can be at least one of a seller agent, a listing agent, a buyer agent, a real estate broker, a title agent, a lending agent, and a non-licensed participant.

According to an exemplary aspect of the present invention, the team can include at least one member having sponsored at least one subsequent level of members into the team.

According to an exemplary aspect of the present invention, a bonused member receives a team bonus if the bonused member sponsored at least one other member that was productive, or real estate-based productive.

According to a further exemplary aspect of the present invention, a real estate entity can be a real estate agent, and the collected fee can be a flat fee.

In another exemplary embodiment of the present invention, a method of compensating a plurality of team members within a multi-level real estate team includes the following steps: forming the multi-level real estate team based upon sponsoring of members into the team, the team having at least one of the members having sponsored at least two subsequent levels of members into the team; hierarchically representing the multi-level real estate team in a computer database communicatively associated with a computer; collecting, from a real estate entity, a fee based at least in part on a real estate transaction; placing the collected fee into a revenue pool; determining by the computer, via interrogation against the database, a productivity bonus distribution based at least in part on (i) a first level portion of the revenue pool, and (ii) a second level portion of the revenue pool; and distributing, from the revenue pool, the productivity bonuses based at least in part on the productivity bonus distribution.

In another exemplary aspect of the present invention, the respective team bonuses can be distributed electronically.

According to a further exemplary aspect of the present invention, a real estate entity can be a real estate agent, and the collected fee can be a flat fee.

### BRIEF DESCRIPTION OF DRAWINGS

The present invention is illustrated by way of example, and not in limitation, in the figures of the accompanying drawings, in which:

FIG. 1 illustrates an exemplary multi-level real estate team according to the present invention.

FIG. 2 illustrates an exemplary multi-level real estate team according to the present invention, in which team members are associated with levels.

FIG. 3 illustrates an exemplary productivity bonus schedule based on team member levels.

FIG. 4 illustrates a multi-level real estate team according to the present invention, in which distinctions are made between team members based on productivity.

### DETAILED DESCRIPTION

The invention will now be described in more detail by way of example with reference to the embodiments shown in the accompanying figures. It should be kept in mind that the following described embodiments are only presented by way of example and should not be construed as limiting the inventive concept to any particular physical configuration or order.

Real Estate Entity

According to the present invention, a real estate entity can take on any form of business entity such as, for example and not in limitation, a sole proprietorship, an individual, a company, a limited liability company, a partnership, a limited partnership, a corporation, a real estate broker, a real estate franchise, or any other form of entity that does not destroy, in toto, the utility of the present invention. In an exemplary aspect of the present invention, a real entity can be a real estate brokerage, which can be a listing brokerage and/or a buyer's brokerage, for example and not in limitation. In another exemplary aspect of the present invention, a real estate entity can additionally, or alternatively, include a real estate agent, in which case the agent can be charged a flat fee.

Multi-Level Real Estate Team

According to the present invention, a multi-level real estate team (“team”) is defined as a plurality of team members. Aside from an initial member, who initiates a team, a team member joins the team via sponsorship or recruitment by another team member.

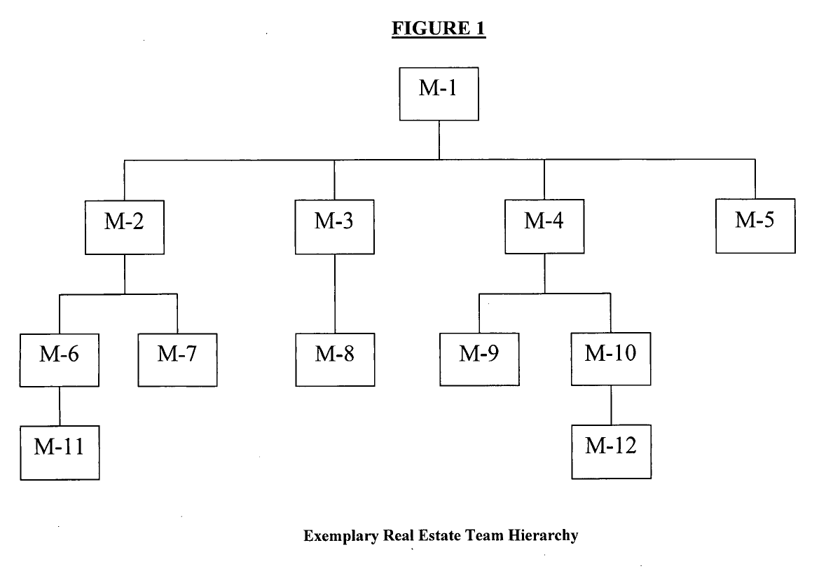

Reference is now made to FIG. 1, which illustrates an exemplary real estate team hierarchy according to the present invention. As illustrated, initial member M-1 is positioned at the top of the hierarchy, as this member initiated the team. As can be further illustrated in this hierarchy, team members M-2, M-3, M-4, and M-5 were directly sponsored or recruited into the team by initial member M-1. Likewise, team members M-6 and M-7, and M-11, were sponsored by team member M-2, directly and indirectly, respectively. Accordingly, this illustrative hierarchy depicts the relationship of sponsorship or recruitment that formed this exemplary team.

According to another exemplary aspect of the present invention, a team can be optionally defined as having at least one member who has sponsored at least two subsequent levels of members into the team. Thus, via this limitation, a team must “build” via sponsorship or recruitment such that it achieves this, or any other desired, state before the team can qualify for team bonuses. Additionally, via this limitation, the recognition of sub-teams can be allowed such that single team members can receive an additional productivity bonus based on their inclusion within a sub-team (additionally described below). This form of incentive can assist in the building of teams such that they reach sufficient size to realize positive productivity bonus incentives, as well as other potential benefits. Notably, various other limitations can be imposed alternatively or conjunctively to further incentivize team members. For example and not in limitation, a team can be defined as having at least one member who has sponsored at least one subsequent level of members. The exact definition of any such aspect will be a design choice.

According to the present invention, a real estate entity can encompass myriad aspects, and therefore can include myriad types of individuals and/or entities; and further, engaging in real estate business includes a broad range of activities, such as the sale, lease, and/or option of real property, and even aspects involved in financial aspects of real estate, for example and not in limitation. Therefore, a team member can be drawn from any aspect involved within a real estate entity. Thus, for example and not in limitation, a team member can include at least one of a seller agent, a listing agent, a buyer agent, a real estate broker, a title agent, a lending agent, and a non-licensed participant. Further, it should be noted that the term “agent” throughout this disclosure is hereby expressly intended to additionally include fictitious entities, such as, for example and not in limitation, corporations, companies, partnerships, etc.

According to the present invention, a team can be represented in any type of computer database such that preservation of the hierarchical relationship between the team members is achieved. Also according to the present invention, a computer database is communicatively associated with a computer such that processing of, or interrogation against, the data contained therein can occur.

Also according to the present invention, a team can be construed as a macro-team that includes sub-teams. Thus, for example, referring to FIG. 1, one sub-team can be defined as team members M-1 through M-12, a second sub-team can be defined as team members M-2, M-6, M-7, and M-11, and a third sub-team can defined as team members M-4, M-9, M-10, and M-12. Notably, sub-teams can be defined as requiring a particular number of members and/or a particular number of sponsorship requirements, such that one or more particular goal or logical states, including the establishment of particular incentive benefits, are established.

Collected Fee

In yet another exemplary aspect of the present invention, a fee is collected from a real estate entity for one or more types of real estate transactions. For example, and not in limitation, a fee can be collected for one or more of the sale, lease, and listing of real estate. Further, a fee can differ based on the type of real estate transaction, for example and not in limitation. Thus, for example and not in limitation, a collected fee can be based at least in part on a real estate transaction.

According to the present invention, a fee is collected from a real estate entity. Further, a collected fee can include a fixed and/or variable component, for example and not in limitation. After collection, fees can be placed into a revenue pool.

According to an exemplary aspect of the present invention, fees can be collected in a recurring manner, periodic manner, and/or on a per-event basis (such as a per-transaction basis), in whole or in part, for example and not in limitation. For example and not in limitation, collected fees can include one or more of a variable fee and a fixed fee. Notably, the manner of fee collection can depend, at least in part, on the timing in which productivity bonuses are distributed. In an exemplary aspect, a collected fee can optionally be dependent, at least in part, upon a real estate transaction, such as, for example and not in limitation, being based at least in part on a sales or lease price of real estate.

Determining Productivity Bonuses

According to an exemplary aspect of the present invention, productivity bonuses can be distributed in a recurring manner and/or based on particular events. For example, and not in limitation, productivity bonuses can be distributed on a periodic, event, and/or on a per-transaction basis, in whole or in part. According to another exemplary aspect of the present invention, productivity bonuses can be determined based, at least in part, on the hierarchy between the members of a team. Thus, productivity bonuses can differ between two or more team members within a team, but may alternatively be the same for two or more team members, for example and not in limitation.

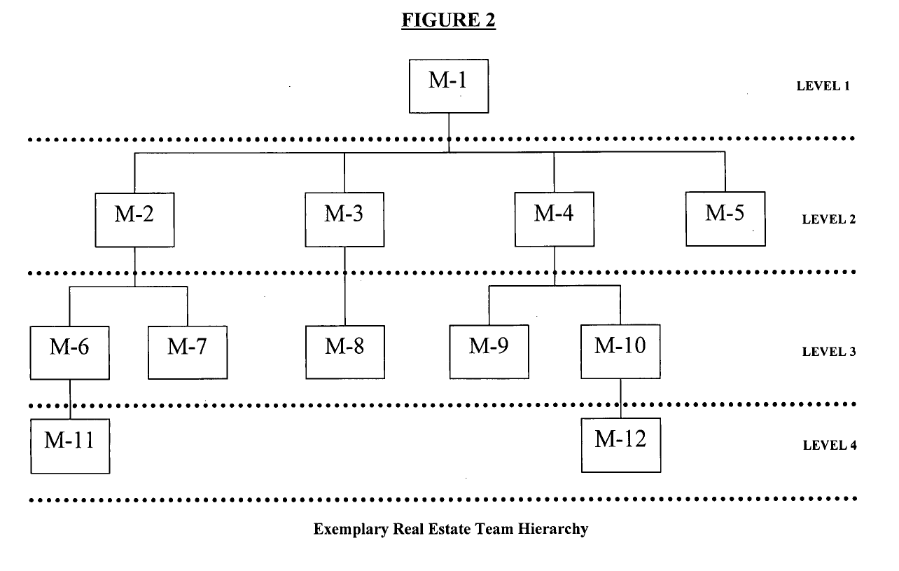

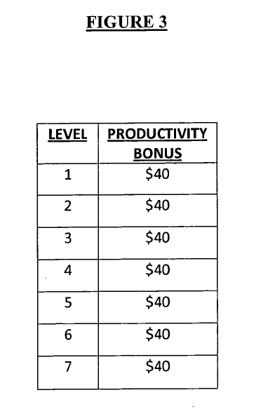

Reference is now made to FIGS. 2 and 3. As illustrated in FIG. 2, a team can include designated levels of team members based on the team member hierarchy, such as Levels 1-4, for example and not in limitation. As illustrated in FIG. 3, an exemplary bonus schedule can include particular bonus amounts that correspond to team hierarchy levels, such as illustrated bonus amounts illustrated for levels 1 through 7, for example and not in limitation. Notably, while the illustrated bonus amounts are the same for each level, this is not required. Any desired distribution that does not destroy all utility of the present invention may be utilized.

Top-Down Productivity Bonus Distribution

For illustrative purposes, the following is an exemplary bonus distribution based on the illustrations provided:

Referring to FIG. 2, the illustrated team includes team members M-1 through M-12, with team member M-1 being at Level 1, team members M-2 through M-5 being at Level 2, team members M-6 though M-10 being at Level 3, and team members M-11 and M-12 being at Level 4. Thus, as per FIG. 3, team member M-1 would receive a productivity bonus of $40 for being at Level 1; team members M-2 through M-5 would receive a team bonus of $40 for being at Level 2; team members M-6 through M-10 would receive a team bonus of $40 for being at Level 3; and team members M-11 and M-12 would receive $40 for being at Level 4.

However, as alluded to above, where sub-teams are recognized, additional productivity bonus distributions can exist. Referring to FIG. 2, a team can be defined, for example and not in limitation, as having at least one member who has sponsored at least two subsequent levels of members into the team. Therefore, in addition to the team emanating from team member M-1 (the macro-team), two additional teams exist within this hierarchy: micro-team one includes team members M-2, M-6, M-7, and M-11; and micro-team two includes M-4, M-9, M-10, and M-12.

Micro-team one qualifies as a team as team member M-2 has sponsored at least two additional levels of members: the first level includes team members M-6 and M-7, and the second level includes team member M-11. Micro-team two qualifies as a team as team member M-4 has sponsored at least two additional levels of members: the first level includes team members M-9 and M-10, and the second level includes team member M-12. It should be noted that a team could have been defined as having at least one member who has sponsored at least one additional level of members, in which case there would be additional micro- or sub-teams in the illustrative team.

Regarding the determination of productivity bonuses for these micro-teams, the level of sponsorship can change, for example and not in limitation. Illustratively, the initially sponsoring team members (here, team members M-2 and M-4) could be considered to be at Level 1. Therefore, as per the exemplary bonus schedule of FIG. 3, team members M-2 and M-4 could each receive a productivity bonus of $40 for being at Level 1 of their respective sub-teams. Accordingly, team members M-6, M-7, M-9, and M-10 would correspondingly receive respective productivity bonuses of $40 for being at Level 2 of their respective sub-teams; and team members M-11 and M-12 would receive productivity bonuses of $40 for being at Level 3 of their respective sub-teams.

As can be seen, the recognition of sub-teams can provide an extraordinarily heightened incentive for a team member to recruit team members who themselves possess recruiting skills, such that a sub-team can be formed and an additional productivity bonus can be realized.

Bottom-Up Productivity Bonus Distribution

For illustrative purposes, the following is another exemplary bonus distribution based on the illustrations provided:

Referring to FIG. 2, the illustrated exemplary team includes team members M-1 through M-12, with team member M-1 being at Level 1, team members M-2 through M-5 being at Level 2, team members M-6 though M-10 being at Level 3, and team members M-11 and M-12 being at Level 4. However, the illustrative bonus schedule of FIG. 3 can be applied in a bottom-up manner. Accordingly, for each particular team member, a productivity bonus can be provided in a level-by-level manner starting from the team member who recruited the particular team member, and continuing upwards until either a maximum level is reached (here, illustratively a seventh level) or a terminal team member is reached (here, illustratively team member M-1). Thus, for team member M-11, team member M-6 would receive a productivity bonus of $40 for being at Level 1, team member M-2 would receive a productivity bonus of $40 for being at Level 2, and team member M-1 would receive a productivity bonus of $40 for being at Level 3. This productivity bonus distribution can be repeated for each team member of the team. As can be seen, team members M-11 and M-12 would not receive a productivity bonus under this distribution, as they have not sponsored or recruited any team members. Notably, with the recognition of sub-teams, this bottom-up productivity bonus distribution can provide multiple productivity bonuses to single team members.

Regarding the determination of productivity bonuses for these micro-teams, the level of sponsorship can change, for example and not in limitation. Illustratively, the initially sponsoring team members (here, team members M-2 and M-4) would be considered to be at level 1. Therefore, as per the exemplary bonus schedule of FIG. 3, team members M-2 and M-4 would each receive a productivity bonus of $40 for being at level 1 of their respective sub-teams. Accordingly, team members M-6, M-7, M-9, and M-10 would correspondingly receive respective productivity bonuses of $40 for being at level 2 of their respective sub-teams; and team members M-11 and M-12 would receive productivity bonuses of $40 for being at level 3 of their respective sub-teams.

Optional Productivity Bonus Requirements

According to yet another exemplary aspect of the present invention, particular requirements can be imposed upon recruited team members in order for those who recruited them (either directly or indirectly) to receive a productivity bonus and/or for that team member to receive a productivity bonus. For example, and not in limitation, one such requirement can be that a team member must be productive (in some measurable way, whether subjectively or objectively). For example and not in limitation, productivity can be satisfied if a team member is real estate-based productive, such as for example and not in limitation, performing some act that contributes to a real estate transaction or somehow contributes to that team member's role within in a real estate field.

Alternatively or conjunctively, additional exemplary requirements that can be imposed upon a team member may be that the team member must hold one or more licenses and/or be within a particular class of member (seniority-based qualification [e.g., at least one year of membership, etc.], a real estate agent, an active real estate agent, having recruitment-based qualifications [e.g., has recruited at least a particular number of members (or even active members)], etc.), for example and not in limitation.

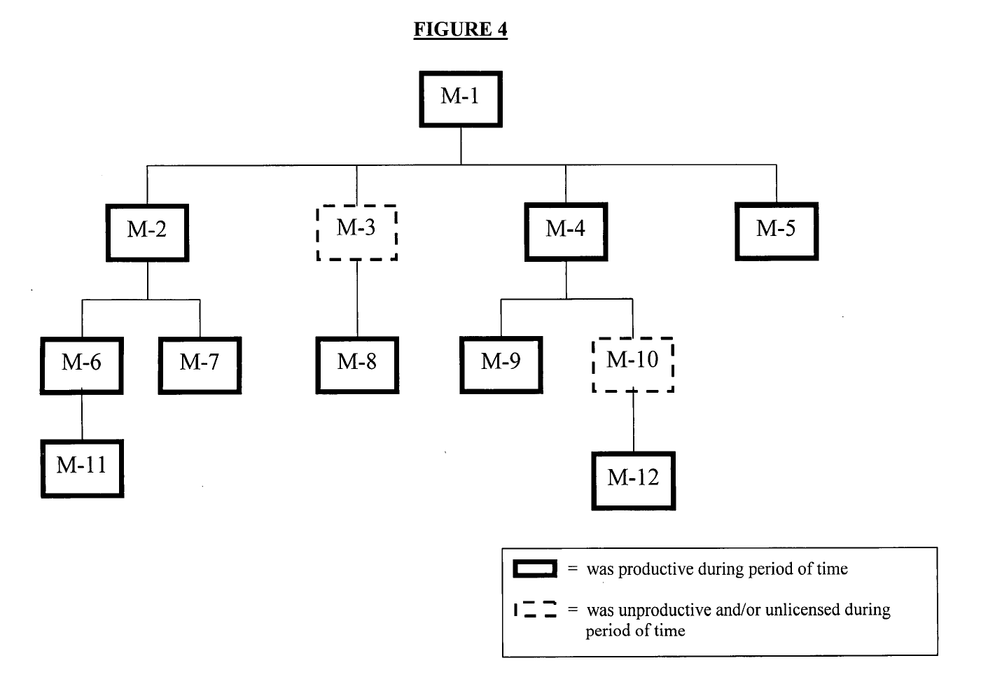

Referring to FIG. 4, illustratively, team members M-3 and M-10 could be determined as having been unproductive and/or unlicensed during some period of time for productivity bonus determination purposes. Thus, in an exemplary top-down productivity bonus distribution, team members M-3 and M-10 may not receive a productivity bonus. Alternatively, in a bottom-up productivity bonus distribution, a productivity bonus may, optionally, not spawn from team members M-3 and M-10; additionally or alternatively, in a bottom-up distribution, productivity bonuses that respectively flow from below team members M-3 and M-10 may be respectively voided or skipped for team members M-3 and M-10.

In yet another exemplary aspect of the invention, distribution of productivity bonuses can be effectuated in any manner consistent with the spirit of the present invention, such as by check, cash, wire transfer, etc. For example, and not in limitation, distribution may be effectuated, in whole or in part, electronically.

It will be apparent to one skilled in the art that the manner of making and using the claimed invention has been adequately disclosed in the above-written description of the exemplary embodiments and aspects taken together with the drawings.

It should be understood, however, that the invention is not necessarily limited to the specific embodiments, aspects, arrangement, and components shown and described above, but may be susceptible to numerous variations within the scope of the invention. Accordingly, the specification and drawings are to be regarded in an illustrative and enabling, rather than a restrictive, sense.

Therefore, it will be understood that the above description of the embodiments of the present invention are susceptible to various modifications, changes, and adaptations, and the same are intended to be comprehended within the meaning and range of equivalents of the appended claims.

Therefore, I claim:

1. A method of compensating a plurality of participants, comprising the steps of:
hierarchically representing, in a database communicatively associated with a computer, a multi-level real estate team, the team being based upon sponsoring of members in the team;
collecting, from a real estate entity, a fee based at least in part on a real estate transaction;
placing the collected fee into a revenue pool;
determining by the computer, via interrogation against the database, a respective productivity bonus for respective team members based at least in part on the hierarchy of the team members; and
distributing, based at least in part on the computer determination, the respective productivity bonuses from the revenue pool to respective team members.

2. The method of claim 1, wherein the collected fee includes at least one fixed component.

3. The method of claim 2, wherein the at least one fixed component is a transaction fee.

4. The method of claim 1, wherein the collected fee includes at least one variable component.

5. The method of claim 4, wherein the at least one variable component is a royalty fee.

6. The method of claim 1, wherein said step of determining includes determining the respective productivity bonus for respective team members based upon: (i) a first level portion of the revenue pool, and (ii) a second level portion of the revenue pool.

7. The method of claim 1, wherein at least one member is at least one of a seller agent, a listing agent, a buyer agent, a real estate broker, a title agent, a lending agent, and a non-licensed participant.

8. The method of claim 1, wherein the team includes at least one member having sponsored at least one subsequent level of members into the team.

9. The method of claim 1, wherein a bonused member receives a productivity bonus if the bonused member sponsored another member that was productive.

10. The method of claim 1, wherein a bonused member receives a productivity bonus if the bonused member sponsored another member that was real estate-based productive.

11. The method of claim 1, wherein the real estate entity is a real estate agent, and the collected fee is a flat fee.

12. A computer system for effectuating a productivity bonus distribution for a multi-level real estate team, comprising:
a database, communicatively associated with a computer, for hierarchically representing the multi-level real estate team, the team being based upon sponsoring of members in the team; and
a determination module for determining via computer interrogation against the database a respective productivity bonus for respective team members based at least in part on the hierarchy of the team members;
wherein the respective productivity bonuses are funded from a revenue pool funded from a fee, collected from a real estate entity, and being based at least in part on a real estate transaction.

13. The system of claim 12, wherein the collected fee includes at least one fixed component.

14. The system of claim 13, wherein the at least one fixed component is a transaction fee.

15. The system of claim 12, wherein the collected fee includes at least one variable component.

16. The system of claim 15, wherein the at least one variable component is a royalty fee.

17. The system of claim 12, wherein said determination module determines the respective productivity bonus for respective team members based upon: (i) a first level portion of the revenue pool, and (ii) a second level portion of the revenue pool.

18. The system of claim 12, wherein at least one team member is at least one of a seller agent, a listing agent, a buyer agent, a real estate broker, a title agent, a lending agent, and a non-licensed participant.

19. The system of claim 12, wherein the team includes at least one member having sponsored at least one subsequent level of members into the team.

20. The system of claim 12, wherein a bonused member receives a productivity bonus if the bonused member sponsored at least one other member that was productive.

21. The system of claim 12, wherein a bonused member receives a productivity bonus if the bonused member sponsored at least one other member that real estate-based productive.

22. The system of claim 12, wherein the real estate entity is a real estate agent, and the collected fee is a flat fee.

23. A method of compensating a plurality of team members within a multi-level real estate team, comprising the steps of:
forming the multi-level real estate team based upon sponsoring of members into the team, the team having at least some of the members having sponsored at least two subsequent levels of members into the team;
hierarchically representing the multi-level real estate team in a computer database communicatively associated with a computer;
collecting, from a real estate entity, a fee based at least in part on a real estate transaction;
placing the collected fees into a revenue pool;
determining by the computer, via interrogation against the database, a productivity bonus distribution based at least in part on (i) a first level portion of the revenue pool, and (ii) a second level portion of the revenue pool; and
distributing, from the revenue pool, the productivity bonuses based at least in part on the productivity bonus distribution.

24. The method of claim 23, wherein the real estate entity is a real estate agent, and the collected fee is a flat fee.
